(19) United States
(12) Patent Application Publication
(10) Pub. No.: US 2014/0264208 A1
(43) Pub. Date: Sep. 18, 2014

(54) Multi-Purpose Hammer

(71) Applicant: Hsiu-Hua CHANG, Taichung City (TW)

(72) Inventor: Hsiu-Hua CHANG, Taichung City (TW)

(21) Appl. No.: 13/830,596

(22) Filed: Mar. 14, 2013

(51) Int. Cl. B25D 1/04

(52) U.S. Cl. CPC B25D 1/045
USPC 254/26 R

(57) ABSTRACT

A multi-purpose hammer includes a hammer head connected to a handle. The hammer head includes an anvil, two claws, a horn and a protuberance. The claws extend substantially opposite to the anvil. The horn extends from one of the claws. The protuberance is formed between the anvil and the claws.

### BACKGROUND OF INVENTION

1. Field of Invention

The present invention relates to a multi-purpose hammer and, more particularly, to a multi-purpose hammer with an improved fulcrum.

2. Related Prior Art

As disclosed in U.S. Pat. No. 4,290,583, a claw hammer 10 includes a handle 12 connected to a hammer head 14 formed with an anvil portion 22, a clawed portion 24 and a wedge-shaped extending portion 46. The clawed portion 24 of the hammer head 14 includes two claws 26 and 28. The claws 26 and 28 are identical to each other in length and separated from each other by a V-shaped slot 30. The wedge-shaped extending portion 46 is formed with a fulcrum point 50. With the fulcrum point 50, it is possible to remove a nail from an object in which the nail is inserted without having to pivot the handle 12 for a large angle. It is however inefficient and ineffective to use the claws 26 and 28 to pick an object such as a plank of wood.

As disclosed in U.S. Pat. No. 5,027,677, an electrician's utility hammer includes a wooden handle 12 connected to a rear section 20 that includes a front section 16, a rear section 20 and a protuberance 48. The rear portion 20 of the hammer head 10 is tapered in a backward direction. The protuberance 48 is formed on a top surface 46 of the rear section 20 of the hammer head 10. The rear section 20 of the hammer head 10 can be used to pick an object. The protuberance 48 can be used as a fulcrum when this electrician's utility hammer is used to pry an object. It is however impossible to use this electrician's utility hammer to remove a nail from an object in which the nail is inserted.

As shown in FIGS. 4 and 5, a conventional multi-purpose hammer includes a handle 12 connected to a hammer head 20. The hammer head 20 includes two claws 24 and a horn 28. The claws 24 are separated from each other by a V-shaped gap 26. The horn 28 extends from one of the claws 24. The horn 28 is made with an upper face 30. The upper face 30 is a convex face. The hammer head 20 is formed with an upper face 32. The upper face 32 is a flat face. The horn 28 can be used to pick an object. The claws 24 can be used to remove a nail from an object in which the nail is inserted. It is however necessary to pivot the handle 12 for a large angle to remove the nail from the object in which the nail is inserted.

The present invention is therefore intended to obviate or at least alleviate the problems encountered in prior art.

### SUMMARY OF INVENTION

It is the primary objective of the present invention to provide a multi-purpose hammer.

To achieve the foregoing objectives, the multi-purpose hammer includes hammer head connected to a handle. The hammer head includes an anvil, two claws, a horn and a protuberance. The claws extend substantially opposite to the anvil. The horn extends from one of the claws. The protuberance is formed between the anvil and the claws.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a multi-purpose hammer according to the preferred embodiment of the present invention;

FIG. 2 is a side view of the multi-purpose hammer shown in FIG. 1;

FIG. 3 is a top view of the multi-purpose hammer shown in FIG. 1;

FIG. 4 is a perspective view of a conventional multi-purpose hammer; and

FIG. 5 is a side view of the conventional multi-purpose hammer shown in FIG. 1.

### DETAILED DESCRIPTION OF PREFERRED EMBODIMENT

Referring to FIGS. 1 through 3, there is shown a multi-purpose hammer that includes a handle 12 connected to a hammer head 20 according to the preferred embodiment of the present invention. The handle 12 is made with and extends along an axis 14.

The hammer head 20 includes an anvil 22, two claws 24, a horn 28 and a protuberance 40. The anvil 22 extends substantially opposite to the claws 24. The anvil 22 is formed with an upper face 46. The upper face 46 is preferably a concave face. The upper face 46 may be a flat face in another embodiment.

The claws 24 are made with a same length and separated from each other by a V-shaped gap 26. Each of the claws 24 is formed with an upper face 42. The upper face 42 is a convex face. Each of the claws 24 inherently includes a tip 25.

The horn 28 extends from one of the claws 24. The horn 28 is made with an upper face. The upper face of the horn 28 is preferably extension from the upper face 42.

The protuberance 40 is located between the anvil 22 and the claws 24. The protuberance 40 is formed with an upper face 44. The upper face 44 is a convex face. The curvature of the upper face 44 is higher than the curvature of the upper face 42. That is, the upper face 44 is more convex than the upper face 42. The upper face 44 includes an apex 48 that is placed between the tips 25 of the claws 24 and the axis 14 of the handle 12.

In operation, the anvil 22 can be used to hit a nail into an object such as a plank of wood and a wall of concrete. The claws 24 can be used to remove the nail from the object. With the protuberance 40 used as a fulcrum portion placed against the object, it is not necessary to pivot the handle 12 for a large angle to cause the claws 24 to remove the nail from the object. The horn 28 can be used to pick the object.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A multi-purpose hammer including:
a hammer head including an anvil, two claws extending substantially opposite to the anvil, a horn extending from one of the claws, and a protuberance formed between the anvil and the claws; and
a handle connected to the hammer head.

2. The multi-purpose hammer according to claim 1, wherein each of the claws is formed with an upper face, wherein the protuberance is formed with an upper face, wherein the upper face of the protuberance is made with curvature higher than that of the upper face of each of the claws.

3. The multi-purpose hammer according to claim 2, wherein the upper face of each of the claws is a convex face.

4. The multi-purpose hammer according to claim 3, wherein the handle is made with and extends along an axis, wherein each of the claws is formed with a tip, wherein the upper face of the protuberance includes an apex placed between the axis and the tip of each of the claws.

5. The multi-purpose hammer according to claim 4, wherein the anvil is formed with an upper face that is one of a concave face and a flat face.
